(19) United States
(12) Patent Application Publication
(10) Pub. No.: US 2024/0155398 A1
(43) Pub. Date: May 9, 2024

(54) SYSTEMS AND METHODS FOR EARLY MEASUREMENT REPORTING RESULT VALIDITY

(71) Applicant: APPLE INC., Cupertino, CA (US)

(72) Inventors: Qiming Li, Beijing (CN); Dawei Zhang, Saratoga, CA (US); Yang Tang, San Jose, CA (US); Yuexia Song, Beijing (CN); Jie Cui, San Jose, CA (US); Manasa Raghavan, Sunnyvale, CA (US); Xiang Chen, Campbell, CA (US); Rolando E. Bettancourt Ortega, Munich (DE)

(21) Appl. No.: 18/490,871

(22) Filed: Oct. 20, 2023

Related U.S. Application Data
(60) Provisional application No. 63/382,210, filed on Nov. 3, 2022.

(51) Int. Cl. H04W 24/10; H04W 24/08

(52) U.S. Cl. CPC H04W 24/10; H04W 24/08

(57) ABSTRACT

Systems and methods for analyzing a validity of an early measurement report (EMR) measurement result are described herein. A base station may configure a threshold value for EMR result validity and receive, from a user equipment (UE), a first measurement value corresponding to a first time at or before expiration of a timer associated with idle mode or inactive mode measurements. The base station receives, from the UE, a second measurement value corresponding to a second time when a radio resource control (RRC) connection setup or resume procedure starts. The base station then determines, based on a comparison of the threshold value to a difference between the first measurement value and the second measurement value, whether the EMR result is valid.

### CROSS-REFERENCE TO RELATED APPLICATIONS

This application claims the benefit of U.S. Provisional Patent Application No. 63/382,210, filed Nov. 3, 2022, which is hereby incorporated by reference herein in its entirety.

### TECHNICAL FIELD

This application relates generally to wireless communication systems, including wireless communication systems using early measurement reports (EMRs).

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and Institute of Electrical and Electronics Engineers (IEEE) 802.11 standard for wireless local area networks (WLAN) (commonly known to industry groups as Wi-Fi)°.

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

Frequency bands for 5G NR may be separated into two or more different frequency ranges. For example, Frequency Range 1 (FR1) may include frequency bands operating in sub-6 gigahertz (GHz) frequencies, some of which are bands that may be used by previous standards, and may potentially be extended to cover new spectrum offerings from 410 megahertz (MHz) to 7125 MHz. Frequency Range 2 (FR2) may include frequency bands from 24.25 GHz to 52.6 GHz. Note that in some systems, FR2 may also include frequency bands from 52.6 GHz to 71 GHz (or beyond). Bands in the millimeter wave (mmWave) range of FR2 may have smaller coverage but potentially higher available bandwidth than bands in FR1. Skilled persons will recognize these frequency ranges, which are provided by way of example, may change from time to time or from region to region.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a diagram showing an example procedure for a UE to obtain and use a new measurement during an RRC connection setup/resume procedure.

FIG. 2 illustrates a diagram corresponding to example determinations of EMR measurement validity that are based on how far a UE has moved since a T331 timer has expired, according to embodiments herein.

FIG. 3 illustrates a diagram corresponding to example determinations of EMR measurement validity that are based on measurement results of a serving cell, according to embodiments herein.

FIG. 4 illustrates a signaling diagram of an example 4-step RACH procedure, in accordance with some embodiments.

FIG. 5 illustrates a signaling diagram of an example 2-step RACH procedure, in accordance with some embodiments.

FIG. 6 illustrates a diagram corresponding to example determinations of EMR measurement validity for a UE, according to embodiments herein.

FIG. 7 illustrates a diagram corresponding to example determinations of EMR measurement validity that are based on measurement results of a serving cell, according to embodiments herein.

FIG. 8 illustrates a method of a base station for EMR result validation, according to one embodiment.

FIG. 9 illustrates a method of a UE for EMR result validation, according to one embodiment.

FIG. 10 illustrates an example architecture of a wireless communication system, according to embodiments disclosed herein.

FIG. 11 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

Early measurement reporting (EMR) may be supported in some wireless communications systems. In an EMR procedure, a UE may perform radio resource management (RRM) measurement after it enters idle/inactive mode and before a T331 timer expires. Then, when returning to a radio resource control (RRC) connected mode, the UE may report the EMR measurement result of the RRM measurement. Based on this EMR measurement result, the network may be informed which carrier(s) may be suitable for carrier aggregation (CA)/dual connectivity (DC) configuration. In some cases, a UE performs the EMR measurement while the T331 time is running and the network may configure the UE to perform an EMR measurement for a preconfigured amount of time after the UE leaves the connected mode.

However, in practice, the UE may not return to an RRC connected mode within a short time as, in some cases, the UE may want to conserve power. If the T331 timer expires, the UE may stop the EMR measurement and return to the RRC connected mode. But in some such cases, if the return to RRC connected mode occurs much later, the network may not be provided with valid EMR results when the UE returns to the RRC connected mode, e.g., due to propagation delay.

It may be beneficial to develop solutions related to FR2 RRM mobility measurement acquisition and reporting on an FR2 secondary cell (SCell)/secondary cell group (SCG) setup/resume delay for a UE connecting from idle and/or inactive mode.

It may also be beneficial to develop solutions related to improving a FR2 SCell/SCG setup delay from defining new UE measurement procedures and RRM core requirements (including, e.g., whether additional information from the network would help the UE perform those measurements effectively). For such cases, the following sequence of events may be assumed: first, the UE initiates and performs improved measurements when it requests RRC connection setup and/or resumption; and second, after acquiring those improved measurements, the UE subsequently reports those measurements to the network to support SCell/SCG setup.

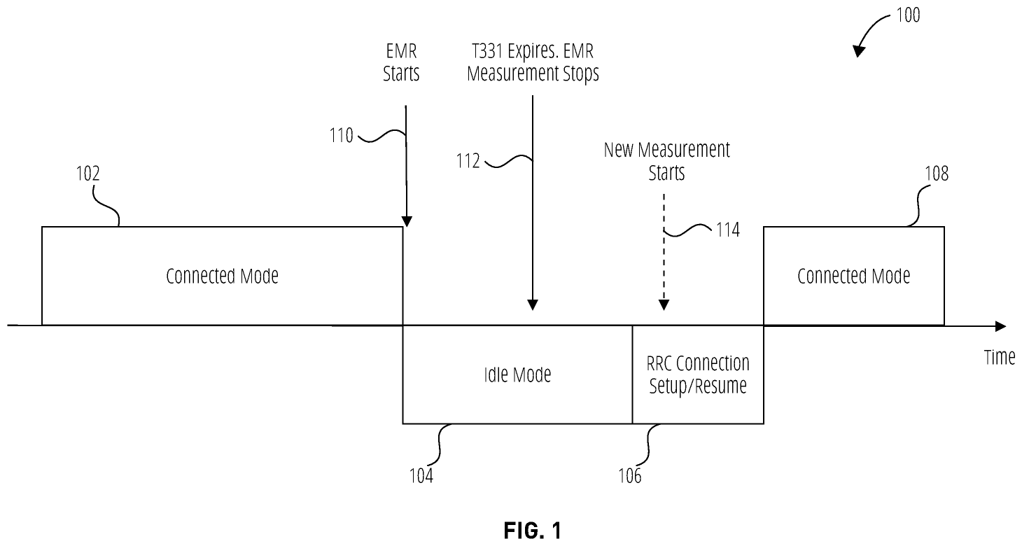

FIG. 1 illustrates a diagram 100 showing a procedure for a UE to obtain and use a new measurement during an RRC connection setup/resume procedure. The UE may begin in an RRC connected mode 102. EMR measurement(s) may start 110 once the UE transitions to an RRC idle mode 104. While the UE is in the RRC idle mode 104, the UE may continue to perform EMR measurement(s) until a T331 timer expires, upon which the EMR measurement(s) stop 112. Then, during an RRC connection setup/resume procedure 106 preparatory to the UE entering the RRC connected mode 108, the UE may start 114 a new measurement.

It may be quite challenging for the UE to have accurate measurements during the RRC connection setup/resume procedure 106 (e.g., as corresponding to a start 114 of such measurements in FIG. 1). The RRC connection setup/resume procedure 106 may last for as little as dozens of milliseconds in some cases. However, it may take hundreds of milliseconds (or even longer) for the UE to have a complete measurement period.

Embodiments described herein relate the use of EMR measurement results (e.g., as taken during the RRC idle mode 104 of FIG. 1) to enable the network to know which carriers are suitable for CA and/or DC after the UE returns to an RRC connected mode (e.g., such as the RRC connected mode 108 of FIG. 1). In some cases, the EMR measurement results may be used instead of a new measurement taken during an RRC connection setup/resume procedure (such as the new measurement of the RRC connection setup/resume procedure 106 of FIG. 1, as has been described). Embodiments herein contemplate the use of such EMR measurement results upon making a determination that EMR measurement results remain valid at the time they are to be used.

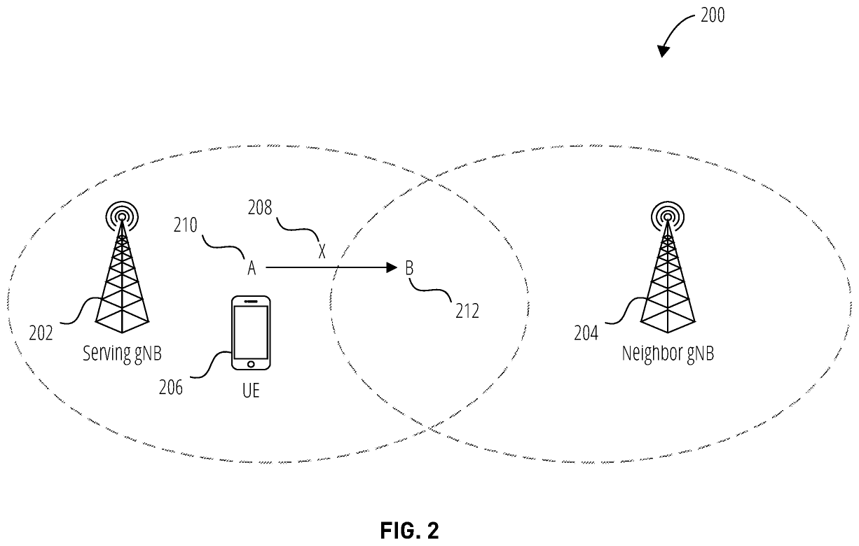

FIG. 2 illustrates a diagram 200 corresponding to determinations of EMR measurement validity that are based on how far a UE 206 has moved since a T331 timer has expired, according to embodiments herein. It will be understood that this distance may correlate, in at least some cases, with an amount of time that a T331 timer has been expired and/or differences of representative measurements of a serving cell, etc. The diagram 200 illustrates a serving gNB 202, a neighbor gNB 204, and a UE 206.

In some embodiments a distance threshold 208 (labelled ‘X’ in FIG. 2) is used to determine the validity of an EMR measurement. This distance threshold 208 may be compared to the distance between a T331 timer expiration location 210 (point A, as illustrated) and an RRC connection setup/resume location 212 (point B, as illustrated), where the T331 timer expiration location 210 is a location of the UE 206 when the T331 timer expires, and where the RRC connection setup/resume location 212 is a location of the UE 206 when an RRC connection setup/resume procedure starts. As an example, if the UE 206 has moved a large distance between the T331 timer expiration location 210 and the RRC connection setup/resume location 212, then the propagation delay for the EMR measurement may be different then if the UE 206 has moved a short distance. As a result, the EMR measurement may be inaccurate due to a differing propagation delay that may incur a different received power. The distance threshold 208 may be a specified value or may be configurable in implementation by the base station.

In some embodiments, the determination of the RRC connection setup/resume location 212 may change based on a type of call. For example, in cases involving a mobile originated (MO) call, the RRC connection setup/resume location 212 may be the position of the UE 206 when a first random access channel (RACH) preamble (Msg1) transmission for the MO call is performed. Further, in cases involving a mobile terminated (MT) call, the RRC connection setup/resume location 212 may be the position of the UE 206 when paging reception for the call is successful.

In other instances, the determination of the RRC connection setup/resume location 212 may be unified for both MO and MT calls, where the RRC connection setup/resume location 212 is the position of the UE 206 when a Msg1 transmission for the call is performed. In some cases the RRC connection setup/resume location 212 is the position of the UE 206 when a first Msg1 transmission for the call is received by the base station.

Then, in cases where the distance between T331 timer expiration location 210 and RRC connection setup/resume location 212 is less than or equal to (or, alternatively, less than) the distance threshold 208, the network may consider that EMR measurement results provided by the UE are still valid. Accordingly, the network may use such EMR measurement results.

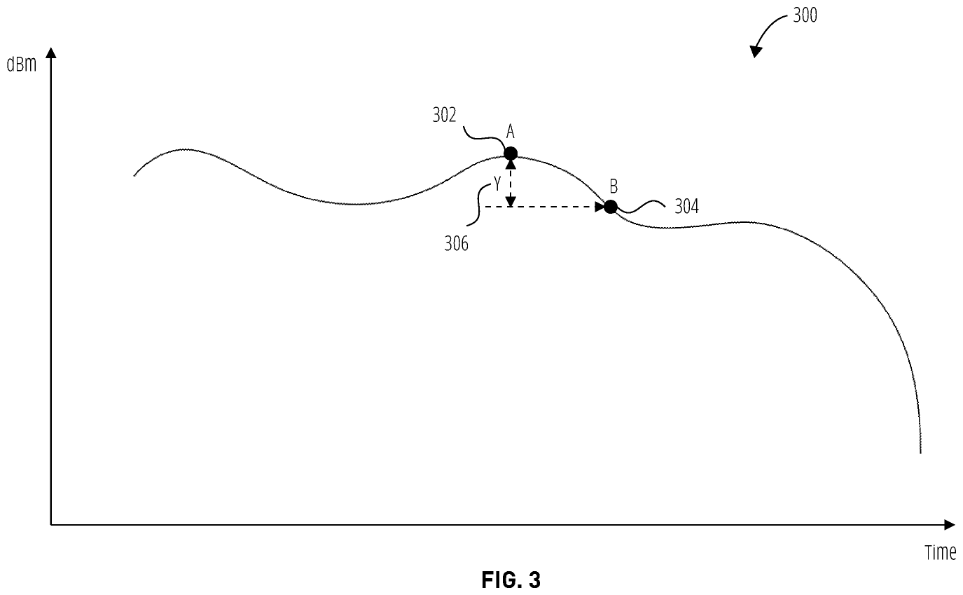

FIG. 3 illustrates a diagram 300 corresponding to determinations of EMR measurement validity that are based on measurement results of a serving cell, according to embodiments herein.

In some embodiments, a power threshold 306 (labelled ‘Y’ in FIG. 3) is used to determine the validity of an EMR measurement. This power threshold 306 may be compared to the difference between a T331 timer expiration measurement 302 and an RRC connection setup/resume measurement 304, where the T331 timer expiration measurement 302 is a last measurement of a serving cell taken at or before a T331 timer expires (point A, as illustrated), and where the RRC connection setup/resume measurement 304 is a measurement result of the serving cell taken corresponding to the start of an RRC connection setup/resume procedure (point B, as illustrated). The power threshold 306 may be a specified value or may be configurable in implementation by the base station.

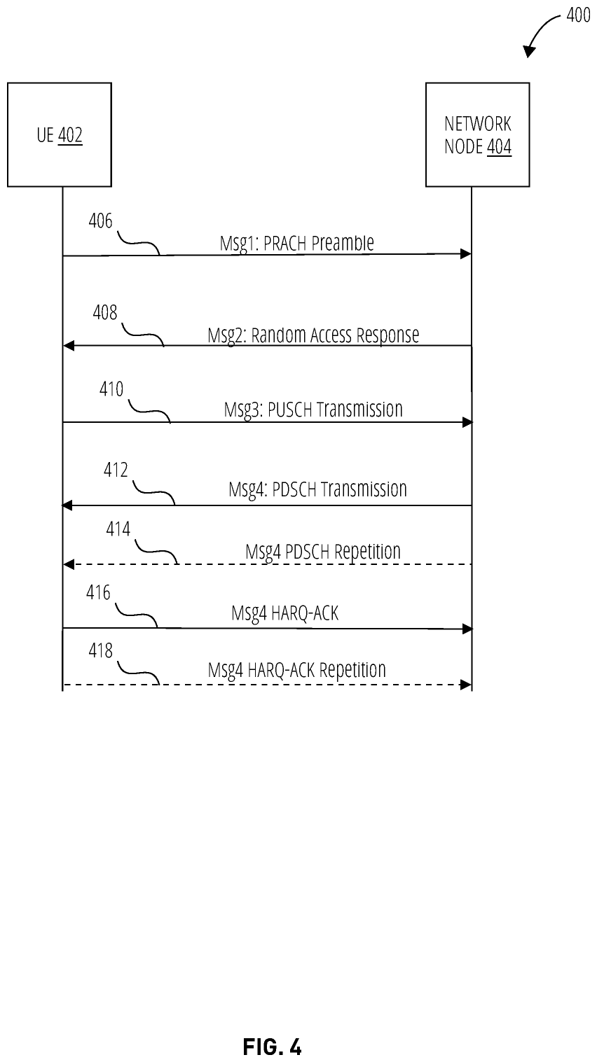

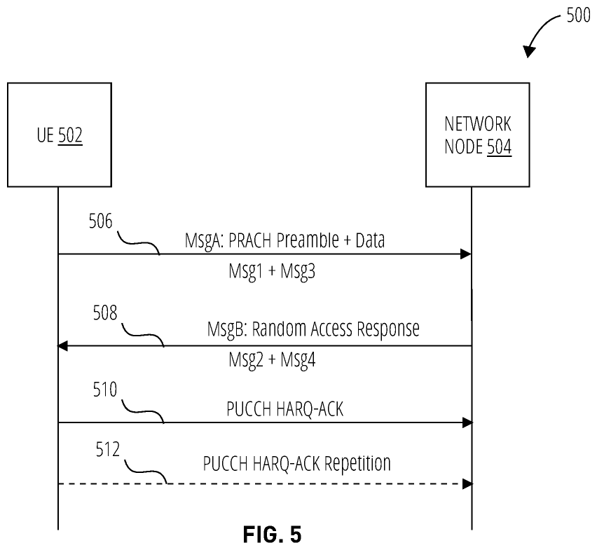

In some instances, the time when RRC connection setup/resume measurement 304 is performed may be determined based on a type of call. For example, in cases involving an MO call, a time of the RRC connection setup/resume measurement 304 may be a time of a Msg1 transmission (as further described in FIG. 4 and FIG. 5) for the MO call. Further, for cases involving an MT call, a time of the RRC connection setup/resume measurement 304 may be a time when paging reception for the call is successful.

In other instances, the time of the RRC connection setup/resume measurement 304 may be unified for both MO and MT calls, where the time of the RRC connection setup/resume measurement 304 is a time when a Msg1 transmission for the call is performed.

In cases where the difference between the T331 timer expiration measurement 302 and the RRC connection setup/resume measurement 304 is less than or equal to (or, alternatively, less than) the power threshold 306, the network may consider that EMR measurement results provided by the UE are still valid. Accordingly, the network may use such EMR measurement results.

The measurements of the serving cell may be, for example, reference signal received power (RSRP) measurements and/or reference signal received quality (RSRQ) measurements.

Value(s) for a distance threshold and/or a power threshold as are described herein may take various forms. In a first option, these thresholds may be fixed values. For example, a distance threshold may be fixed to a value of 400 meters for FR1 and 100 meters for FR2. As another example, a power threshold may be fixed to 3 decibels (dB) for each of FR1 and FR2.

In a second option, it may be that the values of the thresholds may change based on a mobility status of the UE. For example, there may be a first distance threshold and/or power threshold applicable with a stationary UE, a second distance threshold and/or power threshold applicable with a medium mobility UE, and a third distance threshold and/or power threshold applicable with a high mobility UE, etc. In some cases, the mobility status of the UE may be based on a UE velocity (where, for example, a stationary UE is one moving at less than 5 kilometers (km)/hour (h), a medium mobility UE is moving between 5 km/h and 50 km/h, and a high mobility UE is moving faster than 50 km/h).

In some cases, the mobility status of the UE may be based on a defined set of criteria for the wireless communication system (e.g., as in 3GPP Technical Specification (TS) 38.304, “User Equipment (UE) procedures in Idle mode and RRC Inactive state,” version 17.2.0 (September 2022), clauses 5.2.4.9.1 and 5.2.4.9.2 for certain 3GPP-compliant wireless communications systems).

In a first example, clause 5.2.4.9.1 of TS 38.304 provides relaxed measurement criterion for UEs with low mobility. The relaxed measurement criterion for UEs with low mobility may be fulfilled when (Srxlev_{Ref}−Srxlev)<S_{SearchDeltaP}, where Srxlet, is the current Srxlev value of the serving cell in dB. Further, Srxlev_{Ref} is the reference Srxlev value of the serving cell in dB, and is set as follows. In some cases, after selecting or reselecting a new cell, if (Srxlev−Srxlev_{Ref})>0, or, if the relaxed measurement criterion has not been met for T_{SearchDeltaP}, the UE sets the value of Srxlev_{Ref} to the current Srxlev value of the serving cell.

In a second example, clause 5.2.4.9.2 of TS 38.304 provides relaxed measurement criterion for UEs not at a cell edge. The relaxed measurement criterion for UEs not at cell edge is fulfilled when Srxlev>SSearchThresholdP, and when Squal>SSearchThresholdQ, if SSearchThresholdQ is configured, where Srxlev is the current Srxlev et value of the serving cell in dB. Further, SgUC is the current Squal value of the serving cell in dB.

Returning to FIG. 3, in some cases, the mobility status of the UE may be based on a network indication (e.g., a high speed train (HST) flag and/or a highSpeedMeasFlag).

Value(s) for a distance threshold and/or a power threshold may be specified in some cases as predefined value(s). In other cases, they may be specified as part of an EMR configuration. For example, the EMR configuration may include target carriers to be measured, a value of the T331 time, and/or the distance threshold 208 and/or the power threshold 306. In other cases, the distance threshold 208 and/or the power threshold 306 may be specified in a system information block (SIB).

FIG. 4 illustrates a signaling diagram of a 4-step RACH procedure in accordance with some embodiments.

A 4-step RACH procedure may include at least a first message (Msg1), a second message (Msg2), a third message (Msg3), and a fourth message (Msg4) between the UE and a network node. The 4-step RACH procedure may also be referred to as Type-1 RACH. For example, FIG. 4 is a signaling diagram illustrating a RACH procedure 400 by a UE 402 and a network node 404 that may be used in certain embodiments. As shown, the UE 402 may send a Msg1 transmission 406 to the network node 404. The Msg1 transmission 406 may include a physical random access channel (PRACH) preamble including timing information for uplink transmissions.

In response to receiving Msg1 transmission 406, the network node 404 may transmit a Msg2 transmission 408 on a physical downlink control channel (PDCCH) or a physical downlink shared channel (PDSCH). The Msg2 transmission 408 may also be referred to as a random access response (RAR) message. The Msg2 transmission 408 may include timing parameters or information, an uplink grant for the Msg3 transmission 410, a temporary cell radio network temporary identifier (TC-RNTI), etc.

In response to the Msg3 transmission 410, the network node 404 may transmit a Msg4 PDSCH transmissions 412 that may include a contention resolution message. After the UE 402 sends Msg3 transmission 410, a contention resolution timer starts. The network node 404 assists the UE 402 in contention resolution using a cell radio network temporary identifier (C-RNTI) on the PDCCH or using a contention resolution identity information element (IE) on the PDSCH. The UE 402 keeps monitoring the PDCCH before the timer expires and considers the contention resolution successful and stops the timer if the UE 402 obtains the C-RNTI over the PDCCH, or the UE obtains the temporary C-RNTI over the PDCCH and a media access control (MAC) protocol data unit (PDU) is successfully decoded. If the contention resolution timer expires, the UE 402 considers the contention resolution failed.

To enhance coverage of the Msg4 PDSCH transmission 412, the network node 404 may apply repetition to the Msg4 PDSCH Msg4 PDSCH transmission 412. For example, the network node 404 may transmit one or more Msg4 PDSCH repetitions 414. Msg4 PDSCH repetition 414 allows the network node 404 to re-transmit the contention resolution information that was sent via the Msg4 PDSCH transmission 412 at a different time. That way, if the UE 402 fails to receive the Msg4 PDSCH transmission 412 due to interference, the UE 402 will have additional opportunities to receive the Msg4 information.

After the UE 402 receives the Msg4 PDSCH transmission 412 and any repetitions, the UE 402 may send a Msg4 HARQ-ACK 416 to the network node 404 in a physical uplink control channel (PUCCH) or a physical uplink shared channel (PUSCH). The HARQ-ACK timing may be adjusted for Msg4 PDSCH repetitions. The Msg4 HARQ-ACK 416 allows the UE 402 to provide feedback regarding the Msg4 PDSCH transmission 412. To enhance the Msg4 HARQ-ACK 416, the wireless communication system may support the UE sending one or more Msg4 HARQ-ACK repetitions 418. The Msg4 HARQ-ACK repetition 418 comprises the UE repeatedly transmitting the Msg4 HARQ-ACK on the PUCCH. That way, if the network node 404 fails to receive the Msg4 HARQ-ACK 416 due to interference, the network node 404 will have additional opportunities to receive the HARQ-ACK information.

In some embodiments, Msg4 HARQ-ACK repetition with DMRS bundling may be used to enhance Msg4. For DMRS, a time domain window (TDW) may be specified. During the TDW, a UE is expected to maintain power consistency and phase continuity among PUCCH repetitions as HARQ-ACK for Msg4.

FIG. 5 illustrates a signaling diagram of a 2-step RACH procedure in accordance with some embodiments.

A 2-step RACH procedure may reduce the latency of the 4-step RACH procedure, and may include at least a first message (MsgA) and a second message (MsgB). The 2-step RACH procedure may also be referred to as Type-2 RACH. For example, FIG. 5 is a signaling diagram illustrating a 2-step RACH procedure 500 by a UE 502 and a network node 504 that may be used in certain embodiments. As shown, the UE 502 may send a MsgA transmission 506 to the network node 504. The MsgA transmission 506 may include the Msg1 transmission and the Msg3 transmission shown in FIG. 4. In response to receiving MsgA transmission 506, the network node 504 may transmit a MsgB transmission 508 on a physical downlink control channel (PDCCH) or a physical downlink shared channel (PDSCH). The MsgB transmission 508 may include the Msg2 transmission and the Msg4 transmission shown in FIG. 4.

After the UE 502 receives the MsgB transmission 508 (and any repetitions of the MsgB transmission 508), the UE 502 may send a PUCCH HARQ-ACK 510 to the network node 504. The PUCCH HARQ-ACK 510 allows the UE 502 to provide feedback regarding the MsgB transmission 508 (i.e., the Msg2+Msg4 transmission). To enhance the PUCCH HARQ-ACK 510, the wireless communication system may support the UE sending one or more PUCCH HARQ-ACK repetitions 512. The PUCCH HARQ-ACK repetition 512 comprises the UE 502 repeatedly transmitting the PUCCH HARQ-ACK to the network node 504. That way, if the network node 504 fails to receive the PUCCH HARQ-ACK 510 due to interference, the network node 504 will have additional opportunities to receive the HARQ-ACK information. As used herein, for simplicity, reference to Msg4 HARQ-ACK repetition may refer to PUCCH HARQ-ACK repetition for Type-2 RACH.

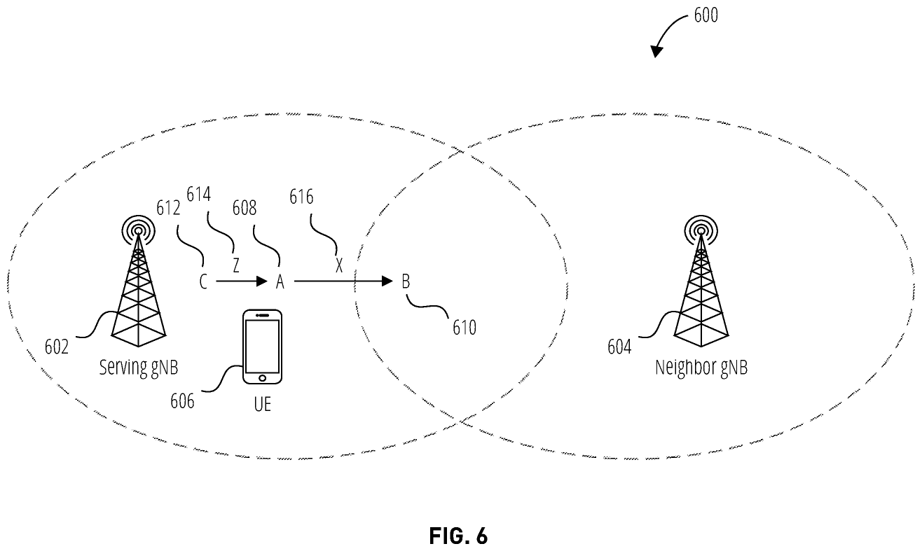

FIG. 6 illustrates a diagram 600 corresponding to determinations of EMR measurement validity for a UE 606, according to embodiments herein. FIG. 6 illustrates a serving gNB 602, a neighbor gNB 604, and a UE 606.

In some cases, it may be that the T331 timer is not an integer multiple of an EMR measurement cycle and/or aligned with the EMR measurement cycle. In such cases, a last sample of an EMR measurement may be taken when the UE is at a last EMR measurement sample location 612 (e.g., point C, as illustrated), which may be earlier than a time at which the T331 timer expires (when the UE is at a T331 timer expiration location 608 (e.g., point A, as illustrated)). For example, if the UE is measuring three carriers while the T331 timer is set to five seconds and each carrier takes one second to measure, the first second the UE may measure the first carrier, the second the UE may measure the second carrier, and the third second the UE may measure the third carrier. This may leave the UE with two extra seconds before the T331 timer expires.

Consider a second example, where a power threshold between when the UE is at a T331 timer expiration location 608 (e.g., point A, as illustrated) and the RRC connection setup/resume location 610 (e.g., point B, as illustrated) may be 3 dB. This may pass validity tests of embodiments disclosed herein if, for example a power threshold 306 is configured as 5 dB. However, if the threshold between a last EMR measurement sample location 612 (e.g., point C, as illustrated) and a T331 timer expiration location 608 (e.g., point A, as illustrated), is, for example, also 3 dB, the threshold between the last EMR measurement sample location 612 (e.g., point C, as illustrated) and the RRC connection setup/resume location 610, (e.g., point B, as illustrated) amounts to 6 dB which is larger than the configured power threshold 306 of 5 dB. Thus, in reality, the EMR measurement is not valid. This example also holds true if the power threshold 306 is substituted for a distance threshold 208.

For determining EMR measurement result validity, it may be that a window 614 (in terms of time, distance, or power variation) between the last EMR measurement sample location 612 and the T331 timer expiration location 608 may matter more than a window between the T331 timer expiration location 608 and the RRC connection setup/resume location 610. Because the timing and manner of performing sampling may be up to UE implementation, the network may not know whether the EMR measurement (e.g., last sample) was performed a long time ago or if the window 614 (whether understood in terms of distance, time difference, or power difference) is relatively small.

To address this, according to certain embodiments, the UE 606 provides information about the window 614 to the network when it returns to a connected mode. This may take the form of an indication transmitted from the UE to the network. Accordingly, information about the window 614 may be signaled from the UE to the network in or with EMR measurement result. In some cases, a particular value for the window 614 may be given in, for example, units of seconds or meters or dB (e.g., integer units of these, or floating point units of these), as applicable. In other cases, information for the window 614 may be specified according to different levels. For example, level 1=less than 1 second or less than 100 meters or less than 1 dB, level 2=1 to 3 seconds or 100 to 300 meters or 1 to 2 dB, and level 3=more than 3 seconds or more than 300 meters or more than 3 dB, as applicable.

In certain embodiments, the UE may send a flag to the network to indicate whether the EMR results are considered valid. Note that in such cases, there may be multiple flags, where each flag may correspond to an EMR result of one carrier. Further, in such cases, the indication whether the EMR result is considered valid may be determined by the UE based upon a measurement taken at the last EMR measurement sample location 612 and the information about the window 614. For example, the UE may determine that the measurement taken at the last EMR measurement sample location 612 may be used by the network for EMR, and may transmit a flag to the network to indicate that the measurement is to be used for EMR.

As illustrated, the information regarding the window 614 (whether understood in terms of distance, time difference, or power difference) may be applied in embodiments (such as those described herein) where a distance threshold 616 (labelled “X” in FIG. 6) is also used as is described herein.

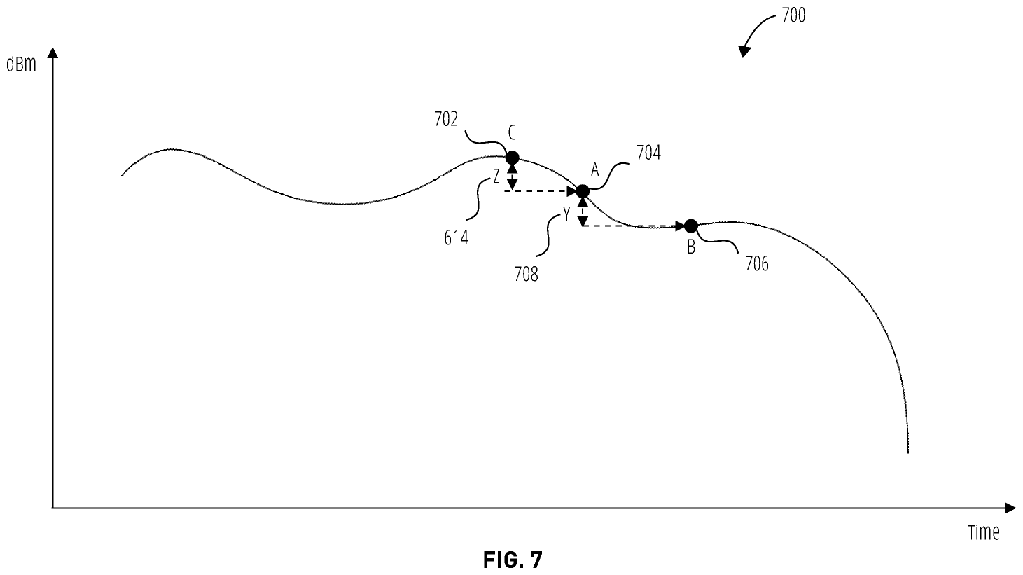

FIG. 7 illustrates a diagram 700 corresponding to determinations of EMR measurement validity that are based on measurement results of a serving cell, according to embodiments herein.

FIG. 7 illustrates how the window 614 first described in relation to FIG. 6 may be conceived when using the power measured by a UE of a serving cell for a last EMR measurement sample measurement 702 (at point C, as illustrated) before a T331 timer expiration 704 (at point A, as illustrated). In such cases, the window 614 corresponds to a difference between the last EMR measurement sample measurement 702 and the T331 timer expiration 704.

As illustrated, the information regarding the window 614 (whether understood in terms of distance, time difference, or power difference) may be applied in embodiments (such as those described herein) where a power threshold 708 (labelled “Y” in FIG. 7) is applied between, e.g., the T331 timer expiration 704 and the RRC connection setup/resume measurement 706, as is described herein.

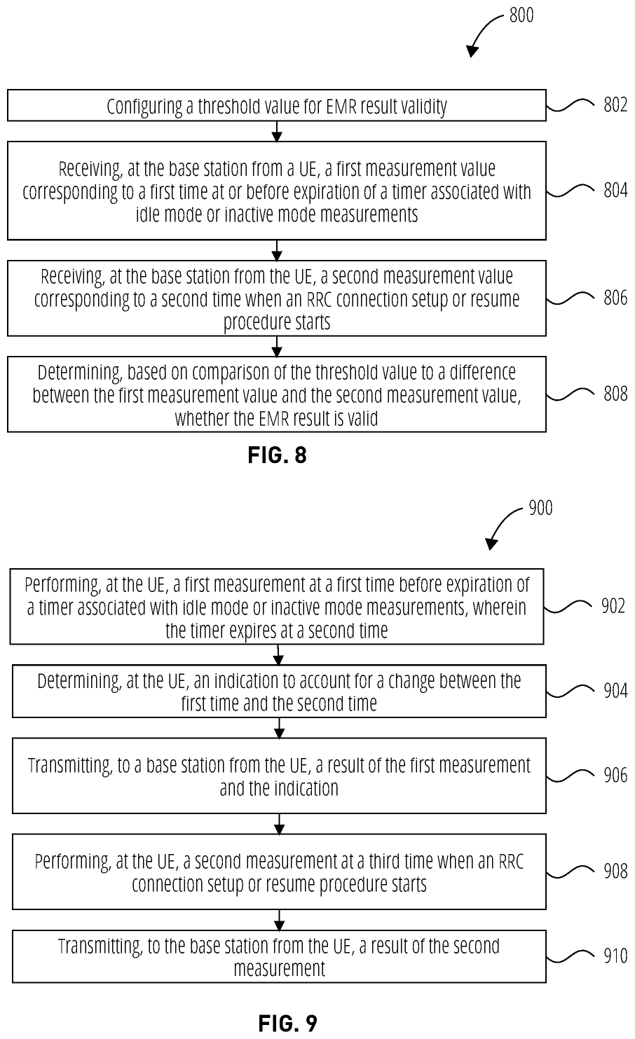

FIG. 8 illustrates a method 800 of a base station for EMR result validation, according to one embodiment. The illustrated method 800 includes configuring 802 a threshold value for EMR result validity. The method 800 further includes receiving 804, at the base station from a UE, a first measurement value corresponding to a first time at or before expiration of a timer associated with idle mode or inactive mode measurements. The method 800 further includes receiving 806, at the base station from the UE, a second measurement value corresponding to a second time when an RRC connection setup or resume procedure starts. The method 800 further includes determining 808, based on a comparison of the threshold value to a difference between the first measurement value and the second measurement value, whether the EMR result is valid.

In certain embodiments of the method 800, the threshold comprises a power threshold.

In certain embodiments of the method 800, the threshold comprises a distance threshold.

In certain embodiments of the method 800, for a mobile originated (MO) call, the second time corresponds to a first random access channel (RACH) preamble (Msg1) transmission for the MO call.

In certain embodiments of the method 800, for a mobile terminated (MT) call, the second time corresponds to a successful paging reception for the MT call.

In certain embodiments of the method 800, for both a mobile originated (MO) call and a mobile terminated (MT) call, the second time corresponds to a first random access channel (RACH) preamble (Msg1) transmission.

In certain embodiments of the method 800, the timer comprises a T331 timer.

In certain embodiments of the method 800, configuring the threshold value includes configuring a fixed value or a set of values for different mobility statuses. In certain such embodiments, the different mobility statuses are selected from a group comprising a UE velocity, a low mobility criterion, and a network indication.

In certain embodiments of the method 800, configuring the threshold value includes: signaling, from the base station to the UE, one or more predefined values; configuring the threshold value together with an EMR configuration provided from the base station to the UE; or configuring the threshold value in a system information block (SIB) broadcast from the base station to the UE.

In certain embodiments, the method 800 further includes: receiving, at the base station from the UE, an indication to account for a third time before the first time; and using the indication when determining whether the EMR result is valid. In certain such embodiments, the indication to account for the third time before the first time comprises a time value between the third time and the first time or a distance value between the third time and the first time or a power value between the third time and the first time. In other embodiments, the indication to account for the third time before the first time comprises a level, wherein the level is a range of times between the third time and the first time or a range of distances between the third time and the first time or a range of powers between the third time and the first time. In other embodiments, the indication to account for the third time before the first time comprises a flag to indicate whether the EMR result is valid.

Embodiments contemplated herein include an apparatus comprising means to perform one or more elements of the method 800. This apparatus may be, for example, an apparatus of a base station (such as a network device 1118 that is a base station, as described herein).

Embodiments contemplated herein include one or more non-transitory computer-readable media comprising instructions to cause an electronic device, upon execution of the instructions by one or more processors of the electronic device, to perform one or more elements of the method 800. This non-transitory computer-readable media may be, for example, a memory of a base station (such as a memory 1122 of a network device 1118 that is a base station, as described herein).

Embodiments contemplated herein include an apparatus comprising logic, modules, or circuitry to perform one or more elements of the method 800. This apparatus may be, for example, an apparatus of a base station (such as a network device 1118 that is a base station, as described herein).

Embodiments contemplated herein include an apparatus comprising: one or more processors and one or more computer-readable media comprising instructions that, when executed by the one or more processors, cause the one or more processors to perform one or more elements of the method 800. This apparatus may be, for example, an apparatus of a base station (such as a network device 1118 that is a base station, as described herein).

Embodiments contemplated herein include a signal as described in or related to one or more elements of the method 800.

Embodiments contemplated herein include a computer program or computer program product comprising instructions, wherein execution of the program by a processing element is to cause the processing element to carry out one or more elements of the method 800. The processor may be a processor of a base station (such as a processor(s) 1120 of a network device 1118 that is a base station, as described herein). These instructions may be, for example, located in the processor and/or on a memory of the base station (such as a memory 1122 of a network device 1118 that is a base station, as described herein).

FIG. 9 illustrates a method 900 of a UE for EMR result validation, according to one embodiment. The illustrated method 900 includes performing 902, at the UE, a first measurement at a first time before expiration of a timer associated with idle mode or inactive mode measurements, wherein the timer expires at a second time. The method 900 further includes determining 904, at the UE, an indication to account for a change between the first time and the second time. The method 900 further includes transmitting 906, to a base station from the UE, a result of the first measurement and the indication. The method 900 further includes performing 908, at the UE, a second measurement at a third time when an RRC connection setup or resume procedure starts. The method 900 further includes transmitting 910, to the base station from the UE, a result of the second measurement.

In certain embodiments of the method 900, for a mobile originated (MO) c all, the third time corresponds to a first random access channel (RACH) preamble (Msg1) transmission for the MO call.

In certain embodiments of the method 900, for a mobile terminated (MT) call, the third time corresponds to a successful paging reception for the MT call.

In certain embodiments of the method 900, for both a mobile originated (MO) call and a mobile terminated (MT) call, the third time corresponds to a first random access channel (RACH) preamble (Msg1) transmission.

In certain embodiments of the method 900, the timer comprises a T331 timer.

In certain embodiments of the method 900, the indication to account for the change between the first time and the second time comprises a time value between the first time and the second time or a distance value between first time and second time or a power value between the first time and the second time.

In certain embodiments of the method 900, the indication to account for the change between the first time and the second time comprises a level, wherein the level is a range of times between the first time and the second time or a range of distances between the first time and the second time or a range of powers between the first time and the second time.

In certain embodiments, the method 900 further includes: determining, at the UE, based on the first measurement result and the change between the first time and the second time, whether current EMR results are valid. In certain such embodiments, the indication to account for the change between the first time and the second time comprises one or more flags to indicate whether the current EMR results are valid. In certain such embodiments, the one or more flags correspond, respectively, to one or more carriers.

Embodiments contemplated herein include an apparatus comprising means to perform one or more elements of the method 900. This apparatus may be, for example, an apparatus of a UE (such as a wireless device 1102 that is a UE, as described herein).

Embodiments contemplated herein include one or more non-transitory computer-readable media comprising instructions to cause an electronic device, upon execution of the instructions by one or more processors of the electronic device, to perform one or more elements of any of the method 900. This non-transitory computer-readable media may be, for example, a memory of a UE (such as a memory 1106 of a wireless device 1102 that is a UE, as described herein).

Embodiments contemplated herein include an apparatus comprising logic, modules, or circuitry to perform one or more elements of the method 900. This apparatus may be, for example, an apparatus of a UE (such as a wireless device 1102 that is a UE, as described herein).

Embodiments contemplated herein include an apparatus comprising: one or more processors and one or more computer-readable media comprising instructions that, when executed by the one or more processors, cause the one or more processors to perform one or more elements the method 900. This apparatus may be, for example, an apparatus of a UE (such as a wireless device 1102 that is a UE, as described herein).

Embodiments contemplated herein include a signal as described in or related to one or more elements of the method 900.

Embodiments contemplated herein include a computer program or computer program product comprising instructions, wherein execution of the program by a processor is to cause the processor to carry out one or more elements of the method 900. The processor may be a processor of a UE (such as a processor(s) 1104 of a wireless device 1102 that is a UE, as described herein). These instructions may be, for example, located in the processor and/or on a memory of the UE (such as a memory 1106 of a wireless device 1102 that is a UE, as described herein).

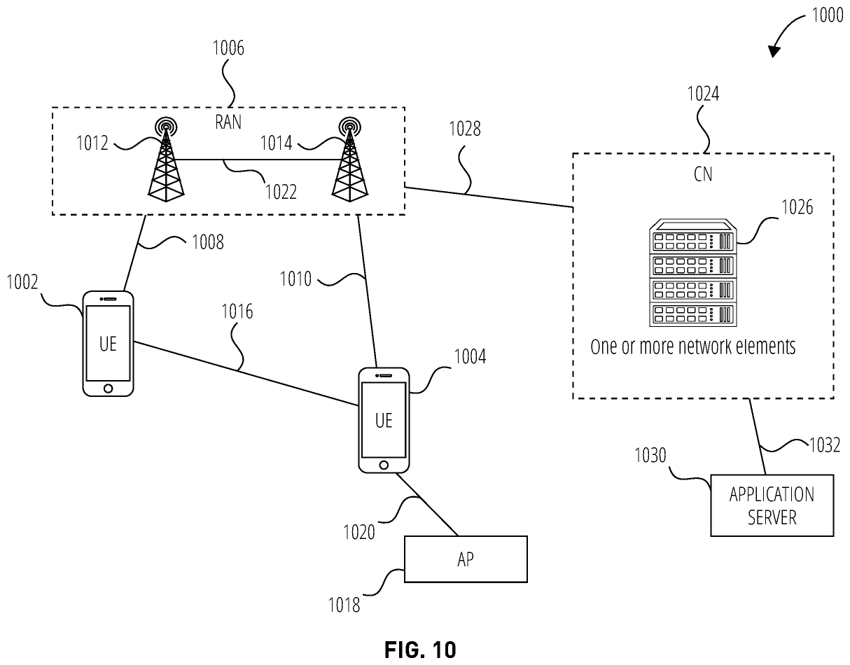

FIG. 10 illustrates an example architecture of a wireless communication system 1000, according to embodiments disclosed herein. The following description is provided for an example wireless communication system 1000 that operates in conjunction with the LTE system standards and/or 5G or NR system standards as provided by 3GPP technical specifications.

As shown by FIG. 10, the wireless communication system 1000 includes UE 1002 and UE 1004 (although any number of UEs may be used). In this example, the UE 1002 and the UE 1004 are illustrated as smartphones (e.g., handheld touchscreen mobile computing devices connectable to one or more cellular networks), but may also comprise any mobile or non-mobile computing device configured for wireless communication.

The UE 1002 and UE 1004 may be configured to communicatively couple with a RAN 1006. In embodiments, the RAN 1006 may be NG-RAN, E-UTRAN, etc. The UE 1002 and UE 1004 utilize connections (or channels) (shown as connection 1008 and connection 1010, respectively) with the RAN 1006, each of which comprises a physical communications interface. The RAN 1006 can include one or more base stations (such as base station 1012 and base station 1014) that enable the connection 1008 and connection 1010.

In this example, the connection 1008 and connection 1010 are air interfaces to enable such communicative coupling, and may be consistent with RAT(s) used by the RAN 1006, such as, for example, an LTE and/or NR.

In some embodiments, the UE 1002 and UE 1004 may also directly exchange communication data via a sidelink interface 1016. The UE 1004 is shown to be configured to access an access point (shown as AP 1018) via connection 1020. By way of example, the connection 1020 can comprise a local wireless connection, such as a connection consistent with any IEEE 802.11 protocol, wherein the AP 1018 may comprise a Wi-Fi® router. In this example, the AP 1018 may be connected to another network (for example, the Internet) without going through a CN 1024.

In embodiments, the UE 1002 and UE 1004 can be configured to communicate using orthogonal frequency division multiplexing (OFDM) communication signals with each other or with the base station 1012 and/or the base station 1014 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 1012 or base station 1014 may be implemented as one or more software entities running on server computers as part of a virtual network. In addition, or in other embodiments, the base station 1012 or base station 1014 may be configured to communicate with one another via interface 1022. In embodiments where the wireless communication system 1000 is an LTE system (e.g., when the CN 1024 is an EPC), the interface 1022 may be an X2 interface. The X2 interface may be defined between two or more base stations (e.g., two or more eNBs and the like) that connect to an EPC, and/or between two eNBs connecting to the EPC. In embodiments where the wireless communication system 1000 is an NR system (e.g., when CN 1024 is a 5GC), the interface 1022 may be an Xn interface. The Xn interface is defined between two or more base stations (e.g., two or more gNBs and the like) that connect to 5GC, between a base station 1012 (e.g., a gNB) connecting to 5GC and an eNB, and/or between two eNBs connecting to 5GC (e.g., CN 1024).

The RAN 1006 is shown to be communicatively coupled to the CN 1024. The CN 1024 may comprise one or more network elements 1026, which are configured to offer various data and telecommunications services to customers/subscribers (e.g., users of UE 1002 and UE 1004) who are connected to the CN 1024 via the RAN 1006. The components of the CN 1024 may be implemented in one physical device or separate physical devices including components to read and execute instructions from a machine-readable or computer-readable medium (e.g., a non-transitory machine-readable storage medium).

In embodiments, the CN 1024 may be an EPC, and the RAN 1006 may be connected with the CN 1024 via an S1 interface 1028. In embodiments, the S1 interface 1028 may be split into two parts, an S1 user plane (S1-U) interface, which carries traffic data between the base station 1012 or base station 1014 and a serving gateway (S-GW), and the S1-MME interface, which is a signaling interface between the base station 1012 or base station 1014 and mobility management entities (MMEs).

In embodiments, the CN 1024 may be a 5GC, and the RAN 1006 may be connected with the CN 1024 via an NG interface 1028. In embodiments, the NG interface 1028 may be split into two parts, an NG user plane (NG-U) interface, which carries traffic data between the base station 1012 or base station 1014 and a user plane function (UPF), and the S1 control plane (NG-C) interface, which is a signaling interface between the base station 1012 or base station 1014 and access and mobility management functions (AMFs).

Generally, an application server 1030 may be an element offering applications that use internet protocol (IP) bearer resources with the CN 1024 (e.g., packet switched data services). The application server 1030 can also be configured to support one or more communication services (e.g., VoIP sessions, group communication sessions, etc.) for the UE 1002 and UE 1004 via the CN 1024. The application server 1030 may communicate with the CN 1024 through an IP communications interface 1032.

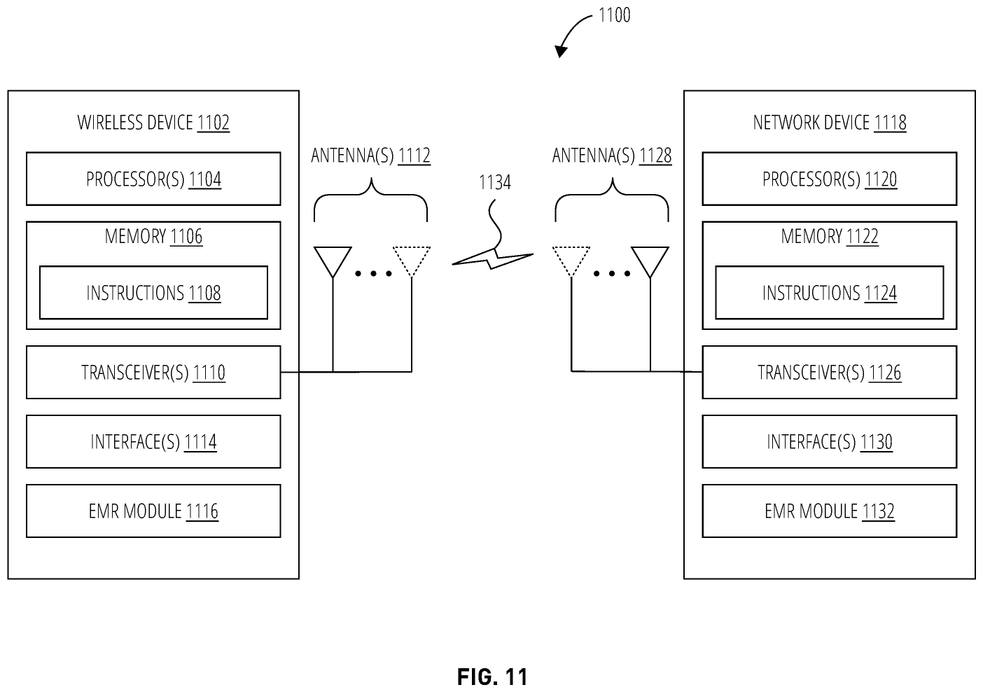

FIG. 11 illustrates a system 1100 for performing signaling 1134 between a wireless device 1102 and a network device 1118, according to embodiments disclosed herein. The system 1100 may be a portion of a wireless communications system as herein described. The wireless device 1102 may be, for example, a UE of a wireless communication system. The network device 1118 may be, for example, a base station (e.g., an eNB or a gNB) of a wireless communication system.

The wireless device 1102 may include one or more processor(s) 1104. The processor(s) 1104 may execute instructions such that various operations of the wireless device 1102 are performed, as described herein. The processor(s) 1104 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1102 may include a memory 1106. The memory 1106 may be a non-transitory computer-readable storage medium that stores instructions 1108 (which may include, for example, the instructions being executed by the processor(s) 1104). The instructions 1108 may also be referred to as program code or a computer program. The memory 1106 may also store data used by, and results computed by, the processor(s) 1104.

The wireless device 1102 may include one or more transceiver(s) 1110 that may include radio frequency (RF) transmitter and/or receiver circuitry that use the antenna(s) 1112 of the wireless device 1102 to facilitate signaling (e.g., the signaling 1134) to and/or from the wireless device 1102 with other devices (e.g., the network device 1118) according to corresponding RATs.

The wireless device 1102 may include one or more antenna(s) 1112 (e.g., one, two, four, or more). For embodiments with multiple antenna(s) 1112, the wireless device 1102 may leverage the spatial diversity of such multiple antenna(s) 1112 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1102 may be accomplished according to precoding (or digital beamforming) that is applied at the wireless device 1102 that multiplexes the data streams across the antenna(s) 1112 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1102 may implement analog beamforming techniques, whereby phases of the signals sent by the antenna(s) 1112 are relatively adjusted such that the (joint) transmission of the antenna(s) 1112 can be directed (this is sometimes referred to as beam steering).

The wireless device 1102 may include one or more interface(s) 1114. The interface(s) 1114 may be used to provide input to or output from the wireless device 1102. For example, a wireless device 1102 that is a UE may include interface(s) 1114 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 1110/antenna(s) 1112 already described) that allow for communication between the UE and other devices and may operate according to known protocols (e.g., Wi-Fi®, Bluetooth®, and the like).

The wireless device 1102 may include an EMR module 1116. The EMR module 1116 may be implemented via hardware, software, or combinations thereof. For example, the EMR module 1116 may be implemented as a processor, circuit, and/or instructions 1108 stored in the memory 1106 and executed by the processor(s) 1104. In some examples, the EMR module 1116 may be integrated within the processor(s) 1104 and/or the transceiver(s) 1110. For example, the EMR module 1116 may be implemented by a combination of software components (e.g., executed by a DSP or a general processor) and hardware components (e.g., logic gates and circuitry) within the processor(s) 1104 or the transceiver(s) 1110.

The EMR module 1116 may be used for various aspects of the present disclosure, for example, aspects of FIG. 1 through FIG. 7 and FIG. 9.

The network device 1118 may include one or more processor(s) 1120. The processor(s) 1120 may execute instructions such that various operations of the network device 1118 are performed, as described herein. The processor(s) 1120 may include one or more baseband processors implemented using, for example, a CPU, a DSP, an ASIC, a controller, an FPGA device, another hardware device, a firmware device, or any combination thereof configured to perform the operations described herein.

The network device 1118 may include a memory 1122. The memory 1122 may be a non-transitory computer-readable storage medium that stores instructions 1124 (which may include, for example, the instructions being executed by the processor(s) 1120). The instructions 1124 may also be referred to as program code or a computer program. The memory 1122 may also store data used by, and results computed by, the processor(s) 1120.

The network device 1118 may include one or more transceiver(s) 1126 that may include RF transmitter and/or receiver circuitry that use the antenna(s) 1128 of the network device 1118 to facilitate signaling (e.g., the signaling 1134) to and/or from the network device 1118 with other devices (e.g., the wireless device 1102) according to corresponding RATs.

The network device 1118 may include one or more antenna(s) 1128 (e.g., one, two, four, or more). In embodiments having multiple antenna(s) 1128, the network device 1118 may perform MIMO, digital beamforming, analog beamforming, beam steering, etc., as has been described.

The network device 1118 may include one or more interface(s) 1130. The interface(s) 1130 may be used to provide input to or output from the network device 1118. For example, a network device 1118 that is a base station may include interface(s) 1130 made up of transmitters, receivers, and other circuitry (e.g., other than the transceiver(s) 1126/antenna(s) 1128 already described) that enables the base station to communicate with other equipment in a core network, and/or that enables the base station to communicate with external networks, computers, databases, and the like for purposes of operations, administration, and maintenance of the base station or other equipment operably connected thereto.

The network device 1118 may include an EMR module 1132. The EMR module 1132 may be implemented via hardware, software, or combinations thereof. For example, the EMR module 1132 may be implemented as a processor, circuit, and/or instructions 1124 stored in the memory 1122 and executed by the processor(s) 1120. In some examples, the EMR module 1132 may be integrated within the processor(s) 1120 and/or the transceiver(s) 1126. For example, the EMR module 1132 may be implemented by a combination of software components (e.g., executed by a DSP or a general processor) and hardware components (e.g., logic gates and circuitry) within the processor(s) 1120 or the transceiver(s) 1126.

The EMR module 1132 may be used for various aspects of the present disclosure, for example, aspects of FIG. 1 through FIG. 8.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method of a base station for early measurement reporting (EMR) result validation, the method comprising:
configuring a threshold value for EMR result validity;
receiving, at the base station from a user equipment (UE), a first measurement value corresponding to a first time at or before expiration of a timer associated with idle mode or inactive mode measurements;
receiving, at the base station from the UE, a second measurement value corresponding to a second time when a radio resource control (RRC) connection setup or resume procedure starts; and
determining, based on a comparison of the threshold value to a difference between the first measurement value and the second measurement value, whether the EMR result is valid.

2. The method of claim 1, wherein the threshold comprises a power threshold.

3. The method of claim 1, wherein the threshold comprises a distance threshold.

4. The method of claim 1, wherein for a mobile originated (MO) call, the second time corresponds to a first random access channel (RACH) preamble (Msg1) transmission for the MO call.

5. The method of claim 1, wherein for a mobile terminated (MT) call, the second time corresponds to a successful paging reception for the MT call.

6. The method of claim 1, wherein for both a mobile originated (MO) call and a mobile terminated (MT) call, the second time corresponds to a first random access channel (RACH) preamble (Msg1) transmission.

7. The method of claim 1, wherein the timer comprises a T331 timer.

8. The method of claim 1, wherein configuring the threshold value comprises configuring:
a fixed value; or
a set of values for different mobility statuses.

9. The method of claim 8, wherein the different mobility statuses are selected from a group comprising a UE velocity, a low mobility criterion, and a network indication.

10. The method of claim 1, wherein configuring the threshold value comprises:
signaling, from the base station to the UE, one or more predefined values;
configuring the threshold value together with an EMR configuration provided from the base station to the UE; or
configuring the threshold value in a system information block (SIB) broadcast from the base station to the UE.

11. The method of claim 1, further comprising:
receiving, at the base station from the UE, an indication to account for a third time before the first time; and
using the indication when determining whether the EMR result is valid.

12. The method of claim 11, wherein the indication to account for the third time before the first time comprises a time value between the third time and the first time or a distance value between the third time and the first time or a power value between the third time and the first time.

13. The method of claim 11, wherein the indication to account for the third time before the first time comprises a level, wherein the level is a range of times between the third time and the first time or a range of distances between the third time and the first time or a range of powers between the third time and the first time.

14. The method of claim 11, wherein the indication to account for the third time before the first time comprises a flag to indicate whether the EMR result is valid.

15. A method of a user equipment (UE) for early measurement reporting (EMR) result validation, the method comprising:
performing, at the UE, a first measurement at a first time before expiration of a timer associated with idle mode or inactive mode measurements, wherein the timer expires at a second time;
determining, at the UE, an indication to account for a change between the first time and the second time;
transmitting, to a base station from the UE, a result of the first measurement and the indication;
performing, at the UE, a second measurement at a third time when a radio resource control (RRC) connection setup or resume procedure starts; and
transmitting, to the base station from the UE, a result of the second measurement.

16. The method of claim 15, wherein for a mobile originated (MO) call, the third time corresponds to a first random access channel (RACH) preamble (Msg1) transmission for the MO call; or
wherein for a mobile terminated (MT) call, the third time corresponds to a successful paging reception for the MT call.

17. The method of claim 15, wherein for both a mobile originated (MO) call and a mobile terminated (MT) call, the third time corresponds to a first random access channel (RACH) preamble (Msg1) transmission.

18. The method of claim 15, wherein the indication to account for the change between the first time and the second time comprises a time value between the first time and the second time or a distance value between first time and second time or a power value between the first time and the second time.

19. The method of claim 15, wherein the indication to account for the change between the first time and the second time comprises a level, wherein the level is a range of times between the first time and the second time or a range of distances between the first time and the second time or a range of powers between the first time and the second time.

20. The method of claim 15, further comprising:
determining, at the UE, based on the first measurement result and the change between the first time and the second time, whether current EMR results are valid,
wherein the indication to account for the change between the first time and the second time comprises one or more flags to indicate whether the current EMR results are valid.
